(19) United States
(12) Patent Application Publication
(10) Pub. No.: US 2008/0240542 A1
(43) Pub. Date: Oct. 2, 2008

(54) DROPLET DETECTION SYSTEM

(75) Inventors: Paul J. Queeney, San Diego, CA (US); Rose Hughes, San Diego, CA (US)

Correspondence Address: GLOBAL PATENT GROUP - KAL;ATTN: MS LAVERN HALL, 10411 Clayton Road, Suite 304, St. Louis, MO, 63131, US

(73) Assignee: KALYPSYS, INC., San Diego, CA (US)

(21) Appl. No.: 11/866,784

(22) Filed: Oct. 3, 2007

Related U.S. Application Data
(60) Provisional application No. 60/849,141, filed on Oct. 3, 2006.

(51) Int. Cl. G01N 35/10; G06K 9/78

(52) U.S. Cl. 382/141

(57) ABSTRACT

A system for a droplet detection device to monitor the dispensing operation in an ultra high throughput (uHTS) system. The system includes a microtitre plate with a defined number of wells and well walls, a dispenser for dispensing fluids into the wells, an illuminating sensor to extract image features from the wells and well walls, and a controller for analyzing the extracted image features to determine the presence or absence of the dispensing fluid on the wells and well walls.

This application claims the benefit of priority of U.S. provisional application No. 60/849,141, filed Oct. 3, 2006, the disclosure of which is hereby incorporated by reference as if written herein in its entirety.

### BACKGROUND OF THE INVENTION

1. Field of the Invention

The present invention relates generally to image analysis in High Throughput Screening (HTS) or Ultra High Throughput Screening (uHTS) system. More specifically, the present invention is directed to a droplet detection system for monitoring the dispensing operation in the HTS or uHTS system.

2. Related Art

Typical procedure for HTS and uHTS systems includes dispensing one or more fluids (e.g., cells, reagents, media, and buffer) into one or more microtitre plates, and transferring such fluids to be incubated, centrifuged, and read. With the exception of the reading step, the process operates in an open loop fashion. Accordingly, if an undesirable condition or malfunction occurs (e.g. the dispenser clogs), the system cannot detect or issue any report of such condition until perhaps the final read step. For a large screening involving hundreds or thousands of plates, a tremendous amount of fluid can be unnecessarily wasted.

More specifically, HTS and uHTS systems generally have one or more dispensing operations where fluid is dispensed into the wells of microtitre plates. Dispense nozzles used for the dispensing operation are generally very small, and therefore can easily be blocked or clogged during the dispensing operation. If one or more of the dispensing nozzles are blocked, then the corresponding wells will be empty. Likewise, if one or more of the dispensing nozzles are partially blocked, then such blockage may cause the dispensing stream to be off target, i.e., the droplets may be dispensed onto the top surfaces of the plate rather than into the corresponding wells.

There is yet a detection system designed to monitor or uncover the above-discussed dispensing conditions in the HTS and uHTS systems. Although various vision or image systems have been implemented for specific applications, such as vial counting, inspecting pipettes, or locating pamphlets, none of such systems has been integrated in a detection system to determine the operation condition of a cell or reagent dispenser.

### SUMMARY OF THE INVENTION

The present invention implements a droplet detection system for monitoring a dispensing operation in a high throughput screening. The system includes a plate with a predetermined number of wells and well walls; a dispenser for dispensing fluid, such as cells, media or reagents, into the wells of the plate; an illuminating sensor to extract image features from the wells and well walls; and a controller for analyzing the extracted image features to determine the presence of the dispensing fluid on the wells and well walls.

The sensor can be a camera or a combination of a camera and vision processing hardware, and can have an array of LEDs to illuminate light onto the plate, or a mirror or partially silvered mirror to reflect light from the array of LEDs onto the plate.

The clog or blocked condition of the dispensing operation is detected either by the controller by measuring variations in light intensity on the well walls, or by measuring fluid content of each of the wells, so as to trigger an operator intervention if needed.

Advantages of the present invention include a more accurate high throughput screening and avoidance of material waste or equipment malfunction caused by a complete or partially blockage of the dispenser during the dispensing operation.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 is an illustration of the droplet detection system according to an exemplary embodiment;

FIG. 2 is a further detailed illustration of the illumination device as shown in FIG. 1;

FIG. 3 is a further detailed illustration of the camera as shown in FIG. 1;

FIG. 4 is an illustration of the camera mounting positions; and

FIG. 5 is a chart showing the software and hardware components of the droplet detection system.

### DETAILED DESCRIPTION OF AN EXEMPLARY EMBODIMENT OF THE INVENTION

While specific exemplary examples, environments and embodiments are discussed below, it should be understood that this is done for illustration purposes only. A person skilled in the relevant art will recognize that other components and configurations can be used without parting from the spirit and scope of the invention. In fact, after reading the following description, it will become apparent to a person skilled in the relevant art how to implement the invention in alternative examples, environments and embodiments.

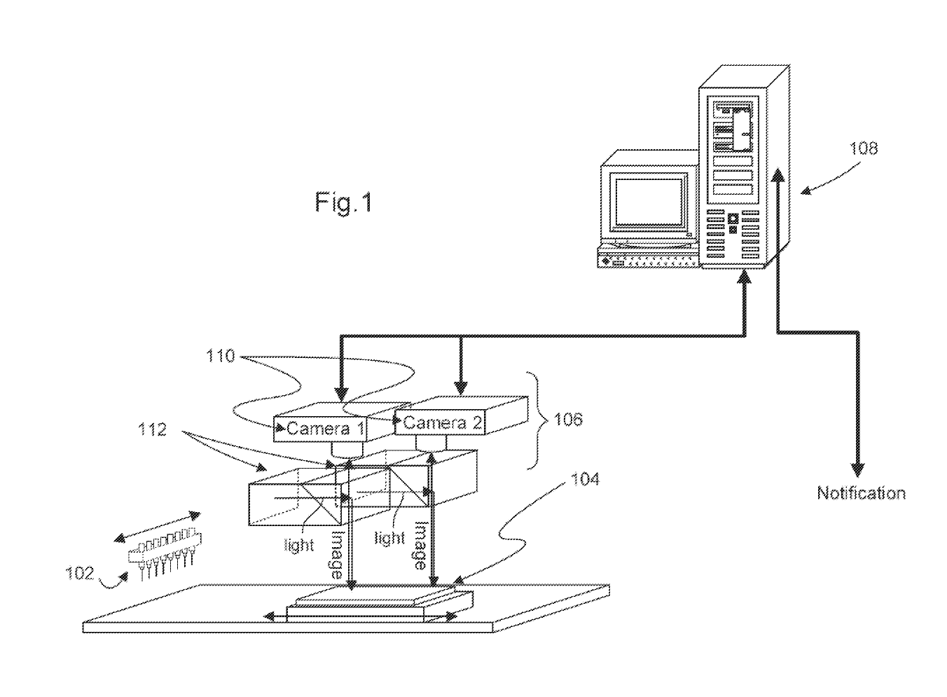

FIG. 1 shows a droplet detection system for monitoring a dispensing operation in a high throughput screening typical according to an exemplary embodiment of the invention. An 8-channel dispenser with y-axis motion 102 for dispensing fluid, reagents, or sample compounds into discrete wells of a microtitre plate 104, which can be, for instance, a 1536-well assay plate having 32 rows and 48 columns of wells that are evenly spaced apart by well walls therebetween. Other plate formats, such as 96-well plate with 8 rows and 12 columns, and 384 plates with 16 rows and 24 columns, can be used as well. The dispenser can be controlled through software such as PDCApp, which is operated by an operator (in stand-alone mode) or by the HTSS computer (in fully automatic mode).

The dispensing nozzles 102 are grouped together and can be mounted on, e.g., a manipulator arm (not shown). Each dispensing nozzle is typically constructed with a tip portion but such can be subjected to clogging. Therefore, an image capturing device 106 is utilized to capture one or more images of the microtitre plate so that such images can be processed by a processor 108 to determine the condition of the microtitre plate 104 due to the occurrence of clogging, if any.

The image capturing device 106 as shown in FIG. 1 is constructed with a pair of cameras 110 and corresponding illumination devices 112, which provide adequate, appropriate and evenly distributed light throughout the entire camera field of view. The image capturing device can also have one or more motion sensors for locating the microtitre plate 104 relative to the cameras 110.

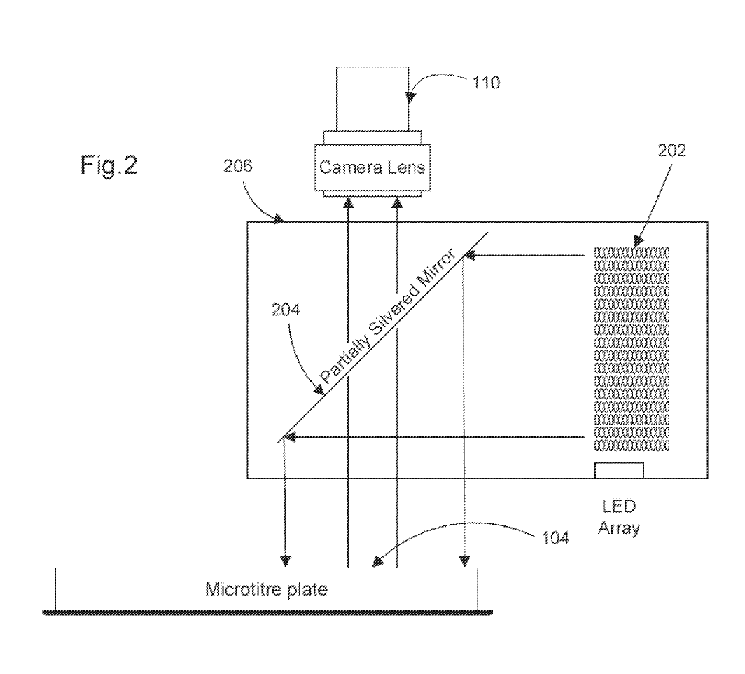

An exemplary structure for the illumination device 112 is shown in FIG. 2. Each of the illumination devices 112 has a light source mounted between the cameras 110 and a portion of the microtitre plate 104 to be inspected. Each illumination device consists of a two-dimensional array of LED's 202, a partially silvered mirror 204, and a housing 206. Light is emitted by the LED array 202 and reflected onto the microtitre plate. The resulting image of the microtitre plate is partially reflected and partially transmitted to the camera.

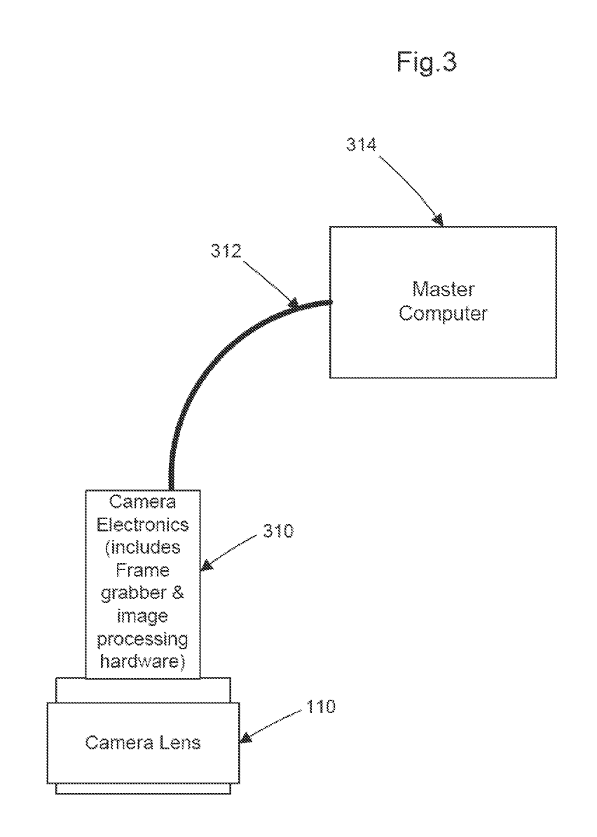

Details of the camera are further illustrated in FIG. 3. Each of the cameras 110, which can be powered by a 24 volt DC power supply, is a specialty device with built-in camera electronics 310 including a frame grabber and an image processor. Each of the cameras 110 consists of a digital camera with a CCD array of a single or multiple dimensions. Particularly, after a picture frame is captured, the image is transferred from the CCD array to a frame grabber. The frame grabber is a specialty computer memory used for storing and processing the image. After the image is transferred, a set of image processing programs is applied against the image to determine if any of the failure modes is detected. After the programs are applied, the results are transferred via an interface cable 312 to a computer control device 314. The master computer 314 has a number of functions, including (1) transferring the set of image processing programs to the image processing hardware in the camera, (2) displaying the images and results, and (3) alerting the operator or other computers if any of the failure modes are detected.

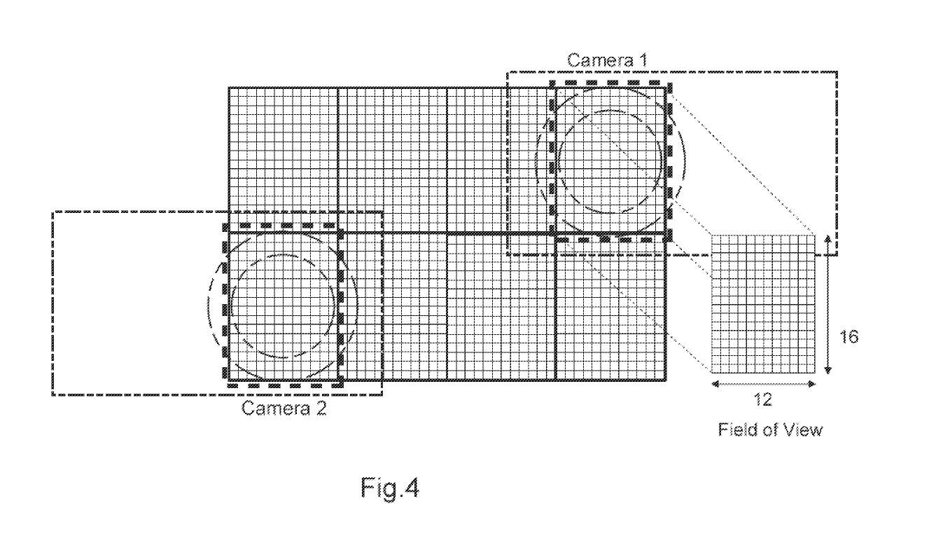

The mounting positions of the cameras are further illustrated in FIG. 4. Each of the cameras' field of view allows processing of 16×12 area of the well section on the 1536-well assay plate. Accordingly, there can be eight (8) field of view sections in each 1536-well assay. Since the cameras are offset, the droplet detection system requires six (6) indexes to acquire a full image of the plate. Particularly, camera 1 will use images from indexes 3, 4, 5 and 6, while camera 2 will use images from indexes 1, 2, 3, and 4.

In one or more embodiments, the steps of the present invention; and the functional steps performed by computer control device 314, are embodied in machine-executable instructions. The instructions can be used to cause a processing device, for example a general-purpose or special-purpose processor, which is programmed with the instructions, to perform the steps of the present invention.

Alternatively, the aforementioned steps can be performed by specific hardware components that contain hardwired logic for performing the steps, or by any combination of programmed computer components and custom hardware components.

For example, the aforementioned steps of the present invention can be provided as a computer program product. In this environment, the invention can include a machine-readable medium having instructions stored on it. The instructions can be used to program any processor (or other electronic devices) to perform a process according to the present invention.

The machine-readable medium can include, for example, floppy diskettes, optical disks, CD-ROMs, and magneto-optical disks, ROMs, RAMs, EPROMs, EEPROMs, magnet or optical cards, or other type of media/machine-readable medium suitable for storing electronic instructions, but is not limited to the foregoing.

In addition, the aforementioned steps of the present invention can also be downloaded as a computer program product. Here, the program can be transferred from a remote computer (e.g., a server) to a requesting computer (e.g., a client) by way of data signals embodied in a carrier wave or other propagation medium via a communication link (e.g., a modem or network connection).

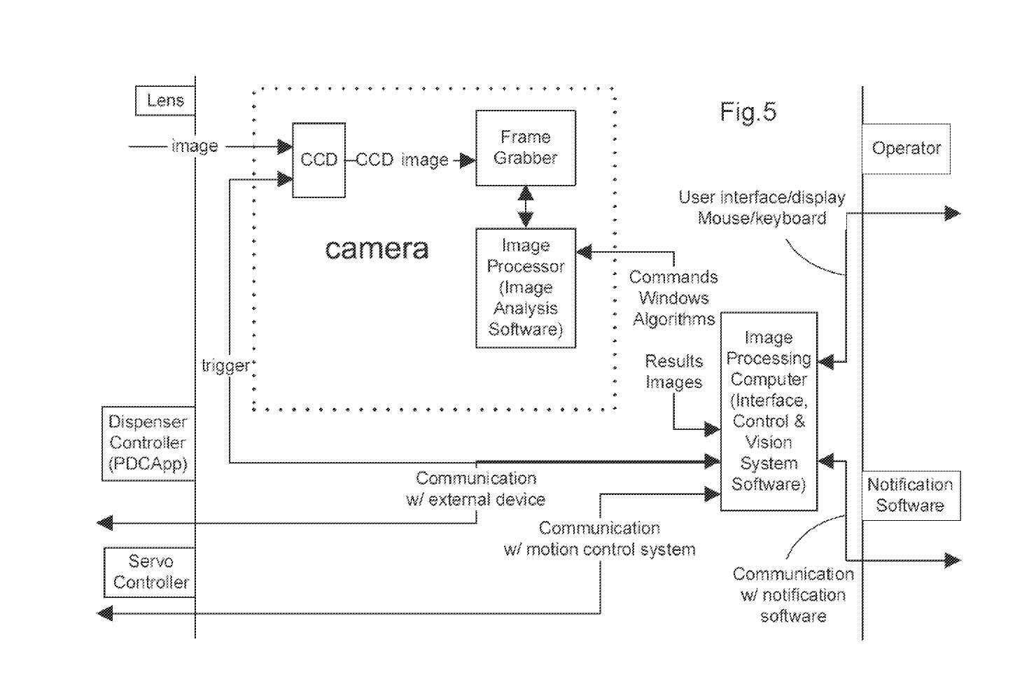

FIG. 5 is a chart showing the software components of the droplet detection system. The software components include a vision system software, image analysis software, and notification software.

The vision system software resides in the image processing computer and is the main operator interface. The operator can enter commands, set windows for algorithms, adjust algorithm parameters, start and stop algorithms, and view images and results. The vision system software also communicates with the camera and image analysis software. Algorithms and inspection windows can be retrieved and images and processing results can be loaded. The camera can be triggered to snap an image. The image processing algorithms can be started and stopped. The vision system software further communicates with the motion controller. The camera may be mounted on a pneumatic or motor driven single or multi-axis stage Such allows the camera to be moved relative to the microtitre plate being inspected. The vision system software yet further communicates with an external device such as a dispenser. The dispenser notifies the vision system software that the dispensing is completed and the plate is ready to be inspected.

The image analysis software resides in the camera and performs the functions of (1) determining the exact position of the plate based on features located on the plate, (2) aligning the image processing windows on the image, (3) analyzing images to detect droplets, (4) analyzing images to detect full and empty wells, and (5) controlling the transfer of information from the frame grabber to and from both the camera and the vision system computer.

The notification software performs the functions of (1) notifying the operator based on notification criteria (e.g., maximum allowable droplets) and actual performance (e.g., number of droplets actually found), (2) providing an operator interface for setting the notification criteria.

Skilled persons will also understand that the use of any terms throughout the specification depicting particular elements or combinations thereof, are provided by way of example, not limitation, and that the present invention can be utilized and implemented by any systems and methods presently known or possible without escaping from the features and functions disclosed herein.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. The droplet detection device for monitoring a dispensing operation in a high throughput system, said device comprising:
a plate with a predetermined number of wells and well walls;
an image capturing device to extract image features from said wells and/or well walls; and
a control processor for analyzing said extracted image features to determine the presence of dispensing fluid on said wells and said well walls.

2. The device of claim 1, wherein said image capturing device comprises a camera and an illumination device.

3. The device of claim 1, wherein said controller detects a clog condition in the dispensing operation by measuring variations in light intensity on the well walls and on surfaces of the plate.

4. The device of claim 1, wherein said controller detects a clog condition in the dispensing operation by measuring fluid content of each of said wells.

5. The device of claim 3, wherein detection of said clog condition triggers an operator intervention.

6. The device of claim 4, wherein detection of said clog condition triggers an operator intervention.

7. The droplet detection device for monitoring dispensing operations in a high throughput system, said device comprising:
a plate with a predetermined number of wells and well walls;
one or more cameras each with built-in electronics to extract image features from said wells and well walls;
a pair of illumination devices adjacent to said cameras, respectively, to distribute reflected light onto said plate; and
a control processor for analyzing said extracted image features to determine the presence of said dispensing fluid on said wells and said well walls.

8. The device of claim 7, wherein said built-in electronics comprise a frame grabber and an image processor.

9. The device of claim 7, wherein said controller detects a clog condition in the dispensing operation by measuring variations in light intensity on the well walls.

10. The device of claim 7, wherein said controller detects a clog condition in the dispensing operation by measuring fluid content of each of said wells.

11. The device of claim 9, wherein detection of said clog condition triggers an operator intervention.

12. The device of claim 10, wherein detection of said clog condition triggers an operator intervention.

13. A method for detecting droplets dispensed in a plate with a plurality of wells in a high throughput system, said method comprising:
dispensing fluids into said wells of said plate;
illuminating said plate with reflected light;
extracting image features from said wells and well walls; and
processing said extracted image features to determine the presence of said dispensing fluid on said wells and said well walls.

14. The method of claim 13, wherein said analyzing step detects a clog condition in the dispensing operation by measuring variations in light intensity on the well walls.

15. The method of claim 13, wherein said analyzing step detects a clog condition in the dispensing operation by measuring fluid content of each of said wells.

16. The device of claim 14, wherein detection of said clog condition triggers an operator intervention.

17. The device of claim 15 wherein detection of said clog condition triggers an operator intervention.

18. A computer readable recording medium having recorded thereon a program for causing a computer to perform the steps of:
interfacing with an operator, camera, external device, or motion controller;
determining one or more positions of a plate and acquiring one or more images of the plate;
aligning one or more image windows onto said one or more images;
analyzing said one or more images to detect droplets and full or empty wells;
controlling information transfer between a frame grabber and said camera; and
notifying the operator based on notification criteria.
